(19) United States
(12) Patent Application Publication
(10) Pub. No.: US 2006/0114408 A1
(43) Pub. Date: Jun. 1, 2006

(54) Strap retracting mechanism for a retractable eyewear retaining strap assembly

(76) Inventor: John Michael Skuro, Virginia Beach, VA (US)

Correspondence Address: John M. Brandt, 60 Thaxter St., Hingham, MA, 02043, US

(21) Appl. No.: 11/334,786

(22) Filed: Jan. 18, 2006

Related U.S. Application Data
(63) Continuation-in-part of application No. 10/807,981, filed on Mar. 24, 2004.
(60) Provisional application No. 60/644,595, filed on Jan. 18, 2005.

(51) Int. Cl. G02C 3/00

(52) U.S. Cl. 351/156

(57) ABSTRACT

A strap retracting mechanism for a retractable eyewear retaining strap assembly consisting of a strap, a hollow eyewear temple for containing the strap, and a flexible strap extension, a rotating drum communicating with the extension and biasing means for withdrawing the extension and strap into the temple. In one embodiment, the rotating drum is disposed within the temple in line with the longitudinal axis of the temple providing a pulley to extend the effective length of a flexible strap extension. In a second embodiment, the rotating drum is vertically disposed at the eyewear frame end of the temple and is rotatably biased by a coil spring. Either a stretchable or inelastic strap extension is wrapped around the vertical drum and is withdrawn into the temple by rotation of the drum.

### CROSS REFERENCE TO RELATED APPLICATIONS

This application is based on the disclosure of Provisional Application Ser. No. 60/644,595, filed Jan. 18, 2005, which is hereby incorporated by reference; and is a continuation in part of application Ser. No. 10/807,981, now U.S. Pat. No. 6,905,206 by the same inventor.

### BACKGROUND OF THE INVENTION

1. Field of the Invention

The invention relates to devices for securing eyewear to the body of a wearer and more particularly relates to strap retracting mechanisms for retaining straps connected to eyewear temple members for holding eyewear in place about the head or neck.

2. Description of the Prior Art

Retaining straps for eyewear or eyeglasses are well known in the prior art. Simple string type retainers having loops at each end to engage eyewear temples are readily available. These devices are usually inelastic and are designed to allow the eyewear to be worn about the neck when removed from the head. Elastic retainers are also sold for use in sports activities to keep the eyewear securely attached to the head. Both of the prior art types of elastic and inelastic retainers are separate units which remain external to the eyewear.

U.S. Pat. No. 4,479,703, Enghofer, discloses a retaining assembly wherein the retaining straps are elastic and retract of there own elasticity into hollow temples. U.S. Pat. No. 6,547,388, Bohn, provides a similar device wherein the retaining strap coils about itself and is adjustable as to effective length by various stop mechanisms.

The above cited U.S. patent, Skuro, provides a retractable assembly for both elastic and inelastic straps so that both an active mode, i.e., secured to the head, and passive mode, for example, around the neck, are available. Additionally, the design allows the straps to be completely retracted when neither form of use is desired.

The present invention improves upon the prior art by introducing a drum mechanism to extend the length of that portion of the strap extension which acts to retract the retaining strap within the hollow temple.

### SUMMARY OF THE INVENTION

The invention may be summarized as a retracting mechanism for a retractable retaining strap for head worn eyewear. By eyewear is meant any framelike device which contains, holds, or supports transparent, clear, colored, and/or corrective lens structures, which frame is supported on the head by the use of temples that fit over the ears. Items such as sunglasses, sight correcting eyeglasses, and safety glasses are all included in the class of eyewear for which the invention is appropriate.

The retracting mechanism is used in conjunction with a hollow temple in which the retaining strap is disposed and is intended to increase the force and efficiency by which the strap is withdrawn into the temple when not extended for use.

The invention provides a rotating drum as a component of the temple. In a first embodiment, the drum is disposed inside the hollow strap containing temple in line with the temple longitudinal axis. The drum functions as a pulley about which a strap extension is wound to increase its length from one end of the temple to the other. The pulley is preferably located at the eyewear frame end of the temple and is positioned such that the strap extension may be fixed at the opposite or head end of the temple.

In a second embodiment, the drum is disposed vertically to the longitudinal axis of the temple at the eyewear end and is rotatably biased by a spring. A strap extension, either flexible or inflexible, is wrapped around the drum and, as the strap and strap extension are withdrawn from the temple, the drum rotates against the pressure of the spring which then provides the rewinding force of retraction.

Both rotating drum embodiments may be advantageously used in association with the sliding block arrangement disclosed in the above referenced U.S. Pat. No. 6,905,206, Skuro, and will be illustrated in conjunction with that system.

These, and other features and advantages of the invention will become more evident from the description of the preferred embodiment accompanied by the drawings which follows.

### DESCRIPTION OF THE DRAWINGS

FIGS. 1a and 1b are partially cut away perspective views of the preferred embodiment of the invention in a first mode of operation;

FIG. 2 is a combination of FIGS. 1a and 1b in a second mode of operation; and

FIG. 3 is a partially cut away perspective view of an additional embodiment of the invention.

### DESCRIPTION OF THE PREFERRED EMBODIMENT

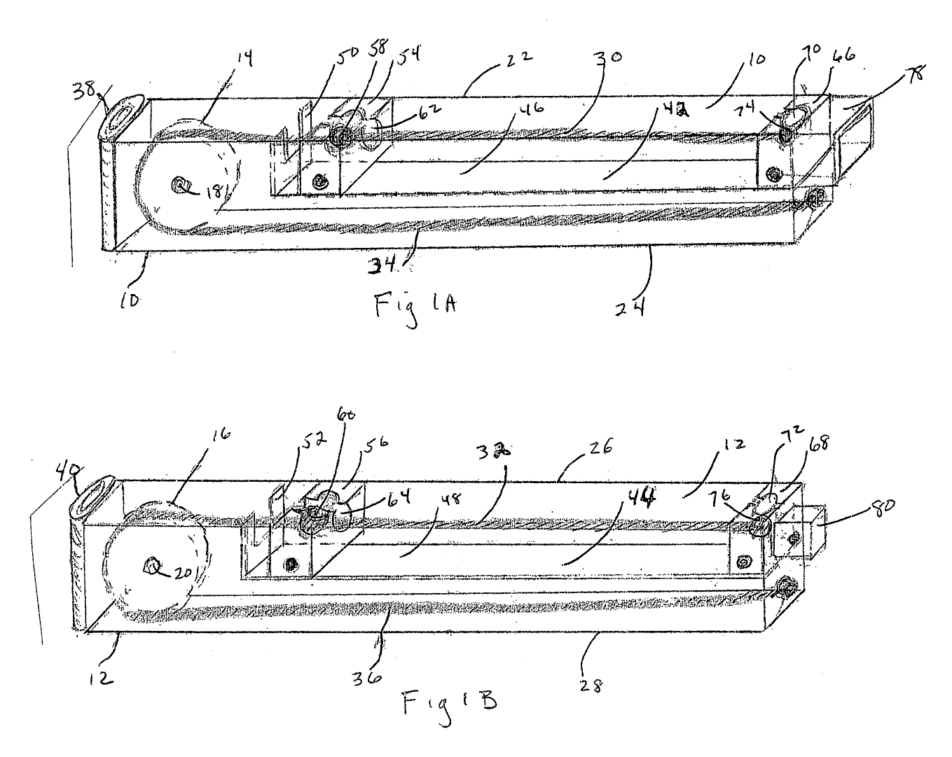

Referring first to FIGS. 1a and 1b, there is shown a perspective schematic illustration of the preferred embodiment of the invention. Each comprises a hollow temple for an eye wear frame forming a right and left pair which in the practice of the invention are interchangeable from side to side. Only one such temple is necessary if only one extendable and retractable strap is desired, it only being necessary that the opposite temple have a suitable connection for the external end of the strap.

Hollow temples 10 and 12 form suitable encasements for rotating pulley drums 14 and 16 mounted on, for example, axels 18 and 20 secured between sidewalls 22 and 24 and 26 and 28 of the respective temples. Extendable retaining straps 30 and 32 are disposed within temples 10 and 12 and are attached to flexible strap extensions 34 and 36 which wrap around drums 14 and 16 and are fastened at the temple end opposite the attachments for the eyewear frames, hinges 38 and 40 for example. Attachment of the extensions may be made by any convenient method such as an adhesive or the use of a cavity block such as described below.

Guide assemblies 42 and 44 disposed within the temple provide one manner in which the extension of retaining straps 30 and 32 may be carried out. Horizontal bases 46 and 48 and vertical retaining walls 50 and 52 disposed within and attached to the sidewalls of the temples provide a compartment for sliding blocks 54 and 56. The blocks provide the junction for and secure straps 30 and 32 and strap extensions 34 and 36 using for example knots 58 and 60 disposed in cavities 62 and 64.

At the further temple ends, a similar arrangement may be used employing blocks 66 and 68 having cavities 70 and 72 in which knots 74 and 76 are secured. Attached to block 66 is a female fastening unit 78 and block 68, a male fastening unit 80.

The blocks and fastening units are held in position, extended or retracted, by, for example, the arrangement utilizing spring biased balls in the blocks and fastening units and recesses in the temples and fastening units as fully described in U.S. Pat. No. 6,905,206 cited above which arrangement is hereby incorporated by reference. Other means may be used such as sliding locking pins, rotating cams, thumbscrews or other mechanical expedients as will be obvious to those skilled in the art.

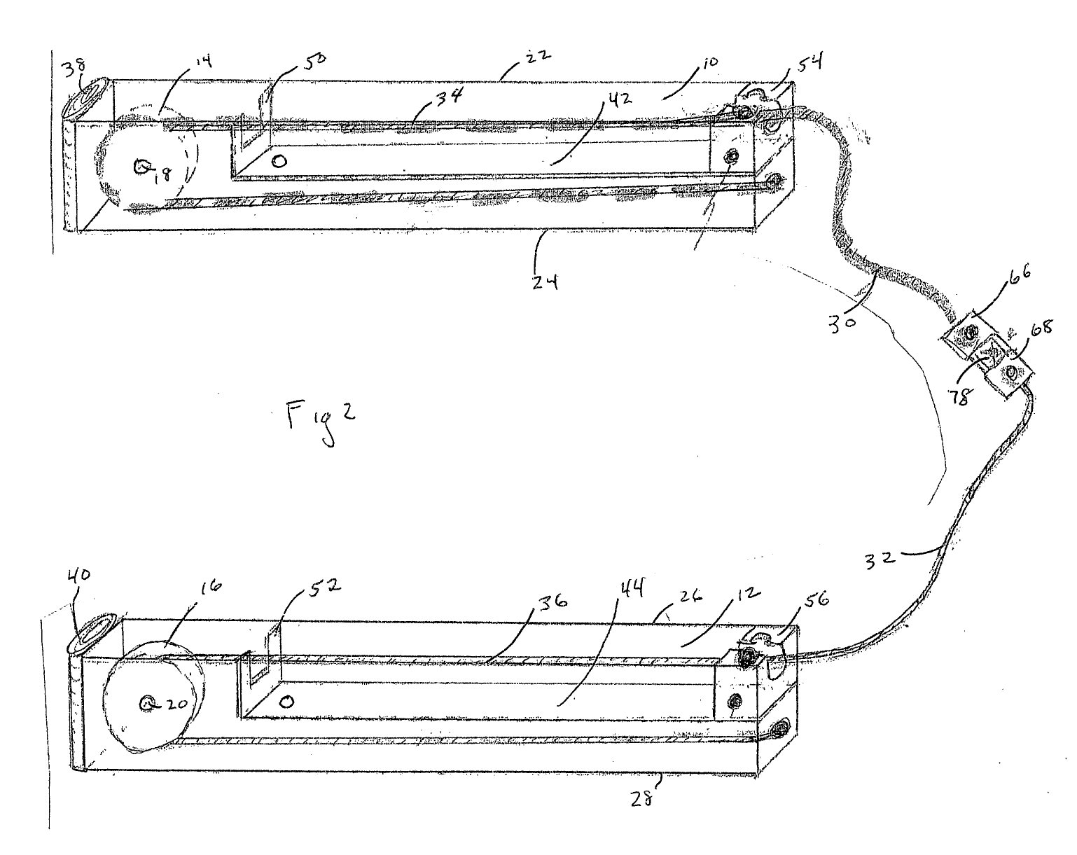

Referring next to FIG. 2, Retaining straps 30 and 32 for their respective temples are shown withdrawn and fastened to one another by the fastening units described above. Blocks 66 and 68 have been released from the ends of the temples and blocks 54 and 56 have also been released from their positions adjacent vertical walls 50 and 52. Strap extensions 34 and 36 are now stretched such that there is a substantial force in reserve to retract the retaining straps back into the temples once fastening units 78 and 80 are released.

As will be seen, rotating drums 14 and 16 provide the means by which flexible stretchable strap extensions 34 and 36 are significantly increased in length from that which would be possible without the drums.

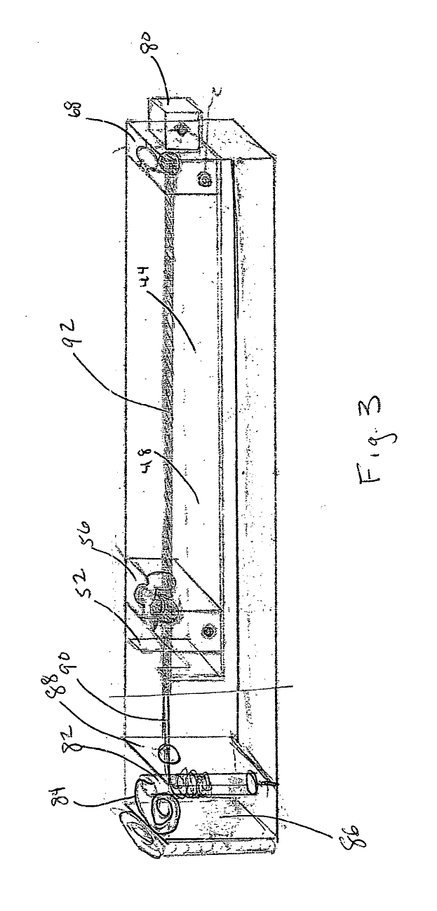

FIG. 3 illustrates an alternative embodiment employing the use of a rotating drum to provide for and enhance the retraction force for extendable retaining straps. As shown, the basic structure of the hollow temple and sliding blocks remains the same but in place of the horizontally disposed drum of the previous embodiment, drum 82 is disposed vertically at the eyewear frame end of the temple. Drum 82 is rotationally biased by for example, coil spring 84. Drum 82 and spring 84 may be disposed in a separate compartment 86 formed by the temple sides and dividing wall 88. Strap extension 90, again secured to retaining strap 92 in the manner described above, is wrapped around drum 82 such that when strap 92 is withdrawn from the temple, coil spring 84 will be compressed or wound to provide the force of retraction at such time as the strap is released from its externally secured position.

As variations in the above described preferred embodiment may be made within the general concept of the disclosure, the invention is accordingly defined by the following claims.

What is claimed is:

1. A strap retracting mechanism for a retractable eyewear retaining strap assembly for an eyewear frame comprising in combination:
A. a hollow temple having a strap receiving end and an eyewear frame attachable end hingeably attachable to said frame;
B. a rotating drum mounted within said temple at said frame attachable end;
C. an eyewear retaining strap disposed within said temple and communicating with said drum, said strap withdrawable from said hollow temple at said strap receiving end;
D. biasing means communicating with said drum and said strap to rotate said drum and withdraw said strap into said temple; and
E. fastening means attached to said eyewear retaining strap, said fastening means attachable to said eyewear.
